(19) United States
(12) Patent Application Publication
(10) Pub. No.: US 2003/0078100 A1
(43) Pub. Date: Apr. 24, 2003

(54) Common connecting device for multiple game machines

(76) Inventor: Wen-Hsiang Hsiao, Taipei (TW)

Correspondence Address: Eugene Mar, BACON & THOMAS, PLLC, Fourth Floor, 625 Slaters Lane, Alexandria, VA, 22314-1176, US

(21) Appl. No.: 09/994,704

(22) Filed: Nov. 28, 2001

(30) Foreign Application Priority Data
Oct. 24, 2001 (CN) 90218200

(51) Int. Cl. A63F 13/00

(52) U.S. Cl. 463/42; 463/46; 463/47

(57) ABSTRACT

A common connecting device for multiple game machines, wherein, an electric circuit device is provided in the body of the circuit device and is formed by arrangement of an electric power loop with a signal integration control loop which is used to synchronically integrate signals from and synchronically distribute signals to the game machines, the game machines are mutually communicated through said signals; thereby, persons can join a game simultaneously, number of players to actually join the game thus is allowed to increase, and a more realistic reciprocating effect thus is obtained.

### BACKGROUND OF THE INVENTION

1. Field of the invention

The present invention is related to a common connecting device for multiple game machines, that is, a connecting device is provided to simultaneously connect with multiple game machines, so that players can join a game simultaneously, number of players can thus be increased for the same game, a more realistic reciprocating effect can thus be obtained.

2. Description of the Prior Art

A conventional single game machine can at most be connected with two operating components for two players to play games; in the case where a game in a software includes multiple members (such as a basketball game, a football game, a baseball game or a battle game), these members can only react according to the internal formulae in the program, such a game is in lack of providing realistic reciprocating feeling, and the formulae do not have tacit understanding with the players, these largely reduce the fun of the game.

Moreover, manufacturers of game machines and software have developed game software for plural persons to play games simultaneously and have improved the functions of the game machines to render the persons to get a realistic reciprocating effect. As shown in FIG. 1, two game machines “A” are connected with each other via a signal connecting line “B” in order that four persons can play games simultaneously, thereby, realistic reciprocating effect among the four persons can be increased. However, such connection of the two game machines “A” can only afford simultaneous game playing of at most four persons, in comparison with the multiple members in the above stated games, the actual number of the persons joining the games is evidently inadequate; and the games still require reciprocal actions from the software itself, and still can not meet the requirement for playing totally by real man players.

### SUMMARY OF THE INVENTION

Thereby, the primary object of the present invention is to provide a common connecting device for multiple game machines, in which, by synchronic integration of signals from and synchronic distribution of signals to the game machines by means of a signal integration control loop, the game machines can be mutually communicated. In this way, a game can be simultaneously played on these game machines, and actual number of players joined the game can be increased; thereby, the persons can get an even truer realistic reciprocating effect.

Another object of the present invention is to provide a common connecting device for multiple game machines, in which, the signal integration control loop is arranged in cooperation with an electric power loop to form an electric device able to be received in the body of the connecting device, and a plurality of signal connecting ports for the signal integration control loop are extended respectively to some sides of the body, an electric power connecting port for the electric power loop is extended to a side of the body; thereby, a complete connecting structure is formed to increase convenience of connecting among the game machines.

The present invention will be apparent after reading the detailed description of the preferred embodiment thereof in reference to the accompanying drawings.

### BRIEF DESCRIPTION OF THE DRAWINGS

FIG. I is a schematic view showing the state of use of a conventional game machine;

FIG. 2 is a perspective view showing the structural appearance of the present invention;

FIG. 3 is a schematic view showing the components of the present invention;

FIG. 4 is an internal electric circuit diagram of the connecting device of the present invention;

FIG. 5 is a schematic view showing the state of use of the present invention.

### DETAILED DESCRIPTION OF THE PREFERRED EMBODIMENT

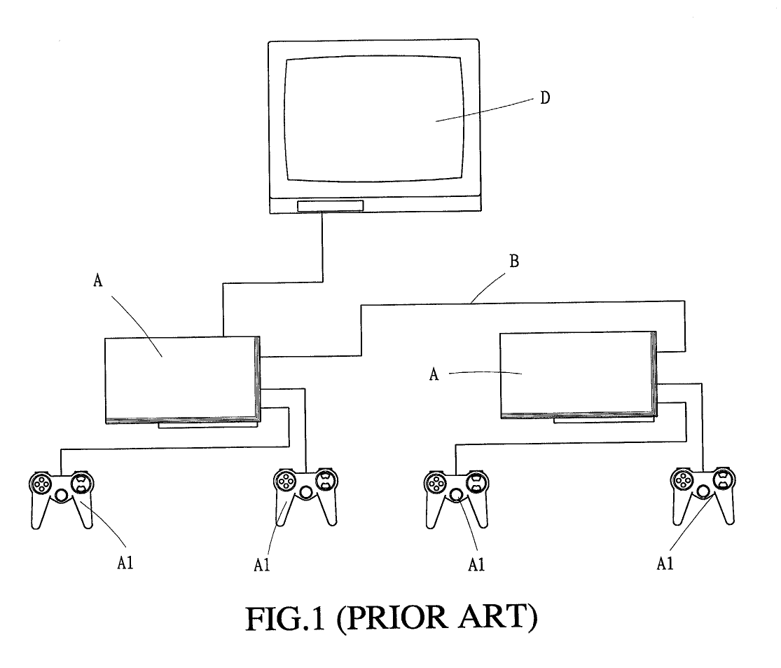

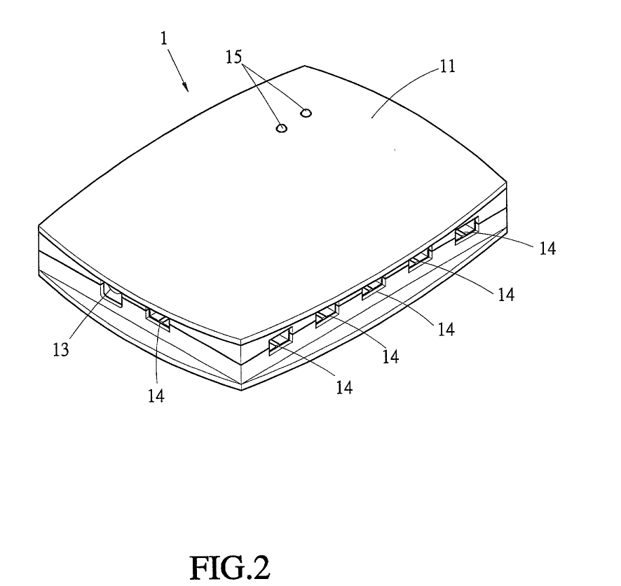

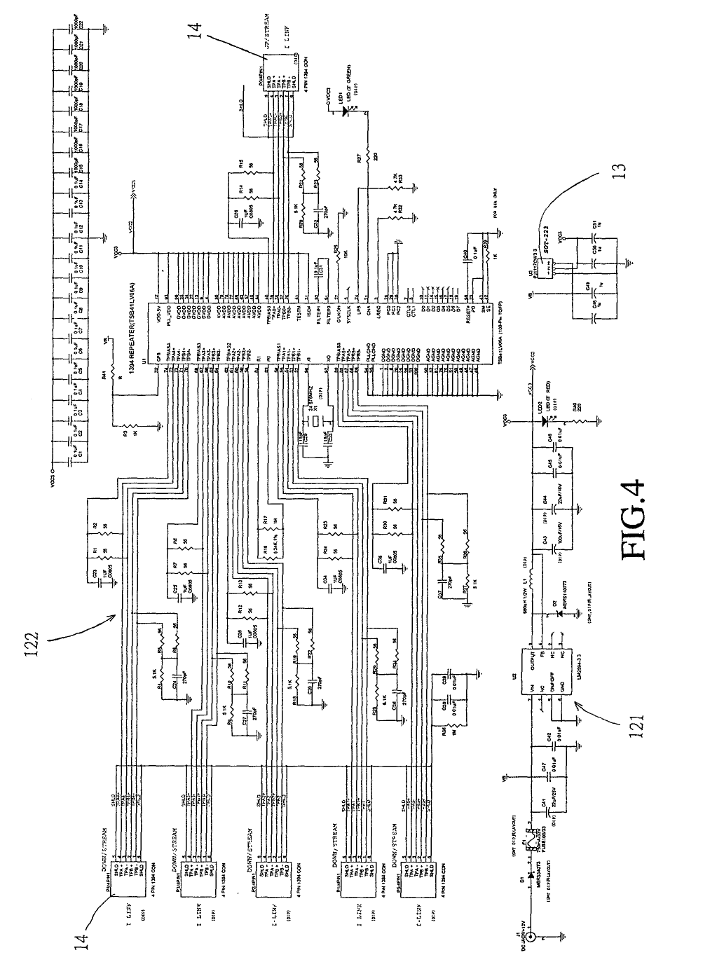

Referring to FIGS. 2 to 4, the components of the common connecting device for multiple game machines of the present invention are shown and include: a body 11, it is the main body of the connecting device 1 used for connecting the game machines; an electric circuit device 12 provided in the body 11, it is formed by arrangement of an electric power loop 121 with a signal integration control loop 122 which is used to synchronically integrate signals from and synchronically distribute signals to the game machines, the game machines can be mutually communicated through the signals; an electric power input port 13 for the electric power loop 121 is extended to a side of the body 1 to supply electric power for the electric circuit device 12 provided in the body 11; and a plurality of signal connecting ports 14 provided respectively on some sides of the body 11 are connected to the signal integration control loop 122 in order that the body 11 is connected with the signal communicating lines of the game machines; thereby, a complete structure of the connecting device 1 is formed by combination of the abovementioned components.

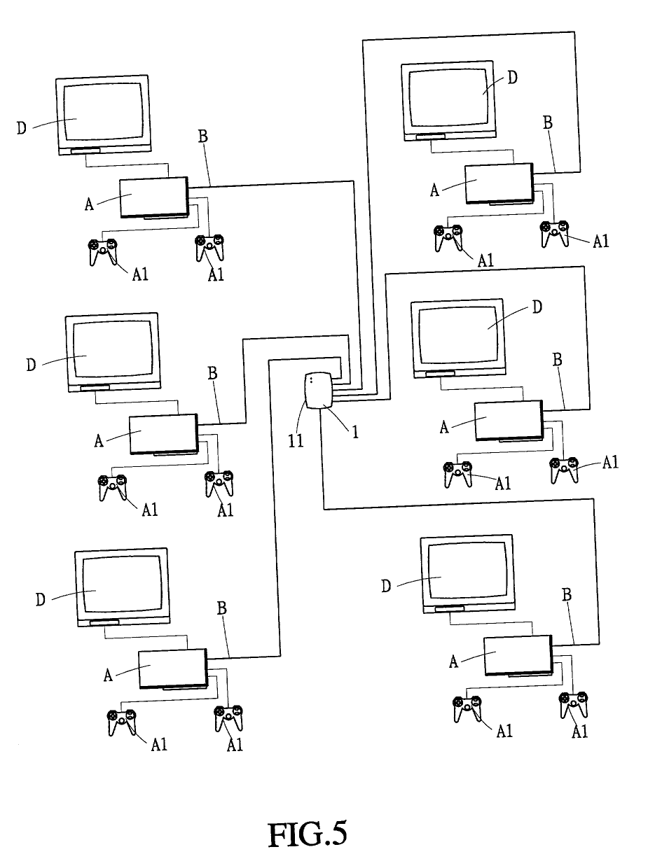

Referring to FIG. 5, the connecting device 1 shown in the drawings is designed to afford use of six game machines “A”, when in practical use, it needs only to respectively connect the signal communicating lines “B” of the game machines “A” with the body 11 of the connecting device 1, signals of the six game machines “A” can communicate mutually, thereby, every game machine “A” can afford playing of two players by using two operating components A1 attached to the game machine “A”. Thereby, a game can allow twelve persons to join personally to get an even more true realistic reciprocating effect.

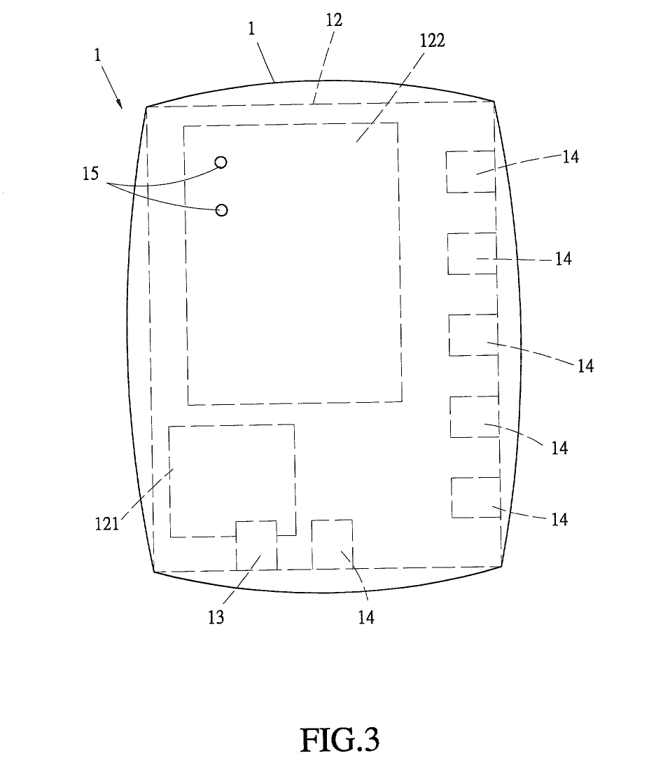

Further, each game machine “A” for mutually connecting through the connecting device 1 can be connected to a monitor “D” and an acoustic equipment (not shown) to elevate the quality of games. And as shown in FIGS. 2 and 3, the connecting device 1 can be provided with an LED 15 in the body 11 thereof in order to indicate in a simple way the state of operation of the internal electric circuit device 12.

The common connecting device for multiple game machines of the present invention has a signal integration control loop used to synchronically integrate signals from and synchronically distribute signals to the game machines, the game machines can be mutually communicated through the signals; so that players can join a game simultaneously, number of players can thus be increased for the same game, a more realistic reciprocating effect can thus be obtained. The present invention thereby provides a preferred structure of connecting device. Having thus described my invention,

What I claim as new and desire to be secured by Letters Patent of the United States are:

1. A common connecting device for multiple game machines comprising components including:
a body which is the main body of said connecting device used for connecting said game machines, an electric circuit device is provided in said body, said circuit device is formed by arrangement of an electric power loop with a signal integration control loop being used to synchronically integrate signals from and synchronically distribute signals to said game machines, said game machines are mutually communicated through said signals;
an electric power input port for said electric power loop being extended to a side of said body to supply electric power for said electric circuit device provided in said body;
and a plurality of signal connecting ports provided on the surface of said body is connected to said electric power loop are connected to said signal integration control loop in order that said body is connected with the signal communicating lines of said game machines;
by combination of said components, a complete structure of said connecting device is formed, with which, signal communicating lines of said game machines are connected with said body of said connecting device in order that persons join a game simultaneously, number of players to actually join said game thus is allowed to increase, a more realistic reciprocating effect thus is obtained.

2. A common connecting device for multiple game machines as in claim 1, wherein, said body is provided with an LED to indicate in a simple way the state of operation of said electric circuit device in said body.
